(19) United States
(12) Patent Application Publication
(10) Pub. No.: US 2006/0174163 A1
(43) Pub. Date: Aug. 3, 2006

(54) Software breakpoints for use with memory devices

(76) Inventors: Stephane Gravoille, Rians (FR); Olivier Debicki, Puyloubier (FR); Jerome Alingry, Aix-En-Provence (FR)

Correspondence Address: SAWYER LAW GROUP LLP, P O BOX 51418, PALO ALTO, CA, 94303, US

(21) Appl. No.: 11/193,817

(22) Filed: Jul. 28, 2005

(30) Foreign Application Priority Data
Jan. 29, 2005 (FR) 05/00533

(51) Int. Cl. G06F 11/00

(52) U.S. Cl. 714/38

(57) ABSTRACT

System and method for providing software breakpoints for use with memory devices. One aspect of the invention includes a microprocessor, a memory device accessible through a data bus and an address bus coupled to the microprocessor, and processing logic coupled to the memory device and to the microprocessor. The processing logic sets the software breakpoint for the memory device by substituting a value to be read from the memory device with a breakpoint pattern that is sent to the microprocessor on the data bus instead of the value.

### FIELD OF THE INVENTION

The present invention relates to microcontrollers and memory devices, and more particularly to the use of software breakpoints in memory devices to halt program execution on microcontrollers.

### BACKGROUND OF THE INVENTION

Developers of microprocessors and other microcontrollers have an extensive process for testing the microcontroller applications they are developing. An important part of this process is the testing of microcontroller routines via the execution of program instructions and the use of a debugging program.

There is typically a need to halt a running program for a variety of reasons when debugging or otherwise. For example, a developer may need to stop the program to determine the values that variables or memory locations have been assigned part-way through program execution, for debugging purposes. Or, an event may occur which requires a program to stop executing, then resume where it left off. Performing debugging operations of code while the system is running is possible with debugging agents (programs) that provide access through the microprocessor and its ports (such as a Joint Test Action Group (JTAG) port).

One way to cause program execution to halt is through the use of breakpoints. Software breakpoints are executed based on instructions processed by a microprocessor during execution of a program. A software breakpoint relies on a breakpoint instruction or “breakpoint pattern” that is stored in the memory accessed by the microprocessor. When the microprocessor reads and recognizes a breakpoint pattern from memory, the microprocessor is forced into a debug state. The breakpoint pattern can be stored in the memory at a particular memory location so that when the program causes the pattern at that location to be executed, the breakpoint occurs. A large number of software breakpoints can be implemented with little additional cost or components, as they require only limited additional logic.

To set a software breakpoint at a particular memory address, the debugging agent (or other program providing the breakpoint) instructs the microprocessor to replace the original instruction at a designated breakpoint address in the memory with the breakpoint pattern. The replaced, original instruction is stored in other memory. During program execution, when the microprocessor reaches the breakpoint address, the breakpoint pattern is fetched and executed, forcing the microprocessor to enter into a debug state. In a debug state, the microprocessor can be instructed to return to non-debug mode by the debugging agent. The original instruction is restored to the breakpoint memory address and executed (in some embodiments, the breakpoint pattern can then replace the original instruction again at the breakpoint address), and the microprocessor is returned to normal execution of the remaining program instructions.

Through a connection to the microprocessor, such as a JTAG port, each debugging agent works as a memory monitor, so that each time a software breakpoint is set, the instruction is replaced in the memory with the breakpoint pattern. Each time the breakpoint is passed over or removed, the breakpoint instruction is replaced in the memory with the original instruction. Thus, setting software breakpoints requires that all system memories be writable.

Software breakpoints are not often used in certain types of memory, such as many types of non-volatile memory, because, to set a software breakpoint, the breakpoint pattern must be written to memory, and most non-volatile memories cannot be written to when using a simple microprocessor write access. Standard ROM is not suitable because data cannot be written to it during operation. Other types of non-volatile memories, such as flash memory, are usually not used with software breakpoints since typical large-sized non-volatile memories used for code storage cannot be written to in the same easy manner as static random access memories (SRAMs). Furthermore, flash memories have a relatively low number of allowed erase cycles before they are worn out, and thus it is highly undesirable to use software breakpoints in them.

Thus, debugging of systems on a chip can be very difficult when these systems embed non-volatile memories, since setting software breakpoints through a debugging agent is not possible or easily accomplished. Some solutions have been suggested. For example, the internal bus activity on circuit outputs can be traced to determine when a program does not execute what it was expected to, but this requires many available circuit outputs; the additional pin count for such a feature would increase the circuit cost. A reduced trace, dedicated to the accesses performed to on-chip target memories, can be performed; however, the package pin number would still need to be increased. These and other suggested solutions are expensive to implement, especially if only used for breakpoint and debug purposes.

Accordingly, what is needed is a method and system for setting and executing software breakpoints in systems having memory devices which are not writable with a simple microprocessor write access, and in which the solution is simple and inexpensive to implement. The present invention addresses such a need.

### SUMMARY OF THE INVENTION

The invention of the present application relates to providing software breakpoints for use with memory devices. In one aspect of the invention, a system for providing a software breakpoint for a memory includes a microprocessor, a memory device accessible through a data bus and an address bus coupled to the microprocessor, and processing logic coupled to the memory device and to the microprocessor, the processing logic operative to set the software breakpoint for the memory device by substituting a value to be read from the memory device with a breakpoint pattern, where the breakpoint pattern is sent to the microprocessor on the data bus instead of the value.

In another aspect of the invention, a method for providing a software breakpoint for use with a memory device includes receiving an address value from a microprocessor in a read access of the memory device, and substituting a data value stored in the memory device with a breakpoint pattern and providing the breakpoint pattern to the microprocessor.

In another aspect of the invention, a method for providing software breakpoints for a memory device includes receiving an address and data in a write access from a microprocessor to the memory device, storing the address in a breakpoint cache in a breakpoint management unit if the data matches a breakpoint pattern, and clearing a stored address in the breakpoint cache of the breakpoint management unit if the data does not match the breakpoint pattern.

The present invention provides an architecture that allows software breakpoints to be used with memory devices in which data cannot be written with a simple microprocessor write access, such as most non-volatile memory devices. The present invention allows multiple such memory devices to be provided with software breakpoints with a minimum of additional logic and registers, thus reducing the cost of the system significantly.

### BRIEF DESCRIPTION OF THE FIGURES

FIG. 1 is a block diagram illustrating a prior art system including a microprocessor and memory devices;

FIG. 2 is a block diagram illustrating a system of the present invention for providing software breakpoints for a non-volatile memory devices;

FIG. 3 is a schematic diagram illustrating an example of the logic used in a software breakpoint management unit of FIG. 2 for clearing and storing software breakpoints;

FIG. 4 is a schematic diagram illustrating an example of the logic used in a software breakpoint management unit of FIG. 2 for providing software breakpoints;

FIG. 5 is a flow diagram illustrating a method of the present invention for setting or clearing software breakpoints in a non-volatile memory; and

FIG. 6 is a flow diagram illustrating a method of the present invention for reading software breakpoints in a non-volatile memory.

### DETAILED DESCRIPTION

The present invention relates to software breakpoints for use with memory devices to halt program execution on microcontrollers. The following description is presented to enable one of ordinary skill in the art to make and use the invention and is provided in the context of a patent application and its requirements. Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

The present invention is mainly described in terms of particular systems provided in particular implementations. However, one of ordinary skill in the art will readily recognize that this method and system will operate effectively in other implementations. The present invention will also be described in the context of particular methods having certain steps. However, the method and system operate effectively for other methods having different and/or additional steps not inconsistent with the present invention.

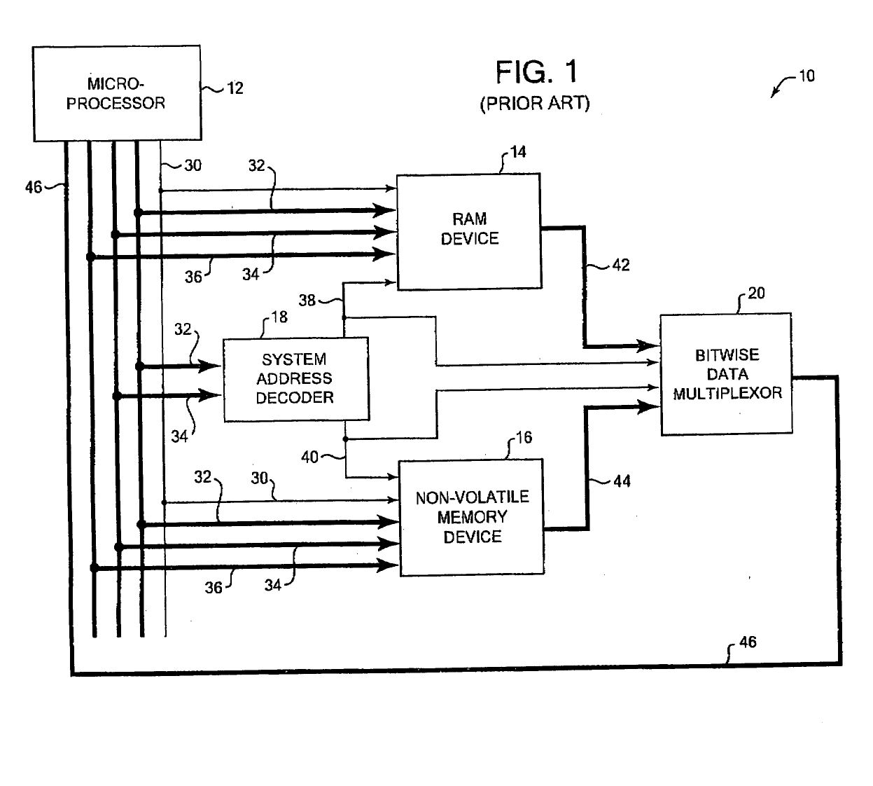

To more particularly describe the features of the present invention, please refer to FIGS. 1 through 6 in conjunction with the discussion below.

FIG. 1 is a block diagram of a prior art system 10 including a microprocessor and on-chip memory devices. System 10 includes microprocessor 12, random access memory (RAM) device 14, non-volatile memory (NVM) device 16, system address decoder 18, and bitwise data multiplexer 20.

Microprocessor 12 generates control signals when performing read or write accesses to slave devices (such as the memory devices 14 and 16). The RAM device 14 is able to store data which can be later overwritten or erased. The NVM device 16 stores data, but cannot traditionally store a software breakpoint pattern, since that pattern cannot be written into the memory with a simple microprocessor write access. For example, non-volatile memory devices such as ROM (read-only memory), EPROM (Erasable Programmable Read-Only Memory) and flash memory, are unsuitable for use with software breakpoint patterns at least for this reason.

The microprocessor 12 control signals include a read/write control signal 30, an access size control bus 32, an address bus 34, and a write data bus 36. The read/write control signal 30 selects the read or write operation for a memory device 14 or 16. The address bus 34 is coupled to the system address decoder 18; the access size control bus 32 can also be coupled to the decoder 18 if address misalignment is to be managed. The system address decoder 18 generates slave select signals to each slave device to indicate to the slave devices to perform a transfer requested by the master (the microcontroller 12), such as a read or a write operation. Slave select signal 38 is sent to RAM device 14, and slave select signal 40 is sent to NVM device 16. The write data bus 36 couples the microprocessor 12 to the memory devices 14 and 16 provides the data from the microprocessor 12 that is to be written in RAM device 14.

For read accesses, the output buses 42 and 44 of the memory devices 14 and 16, respectively, are coupled to the bitwise data multiplexer 20, which multiplexes the output buses 42 and 44 and provides output data on a read data bus 46 that is coupled back to the microprocessor 12.

The prior art system 10 can provide software breakpoints for RAM device 14, but cannot easily use software breakpoints in conjunction with the NVM device 16 or other non-volatile memory devices, and therefore has significant limitations in a debugging and testing environment.

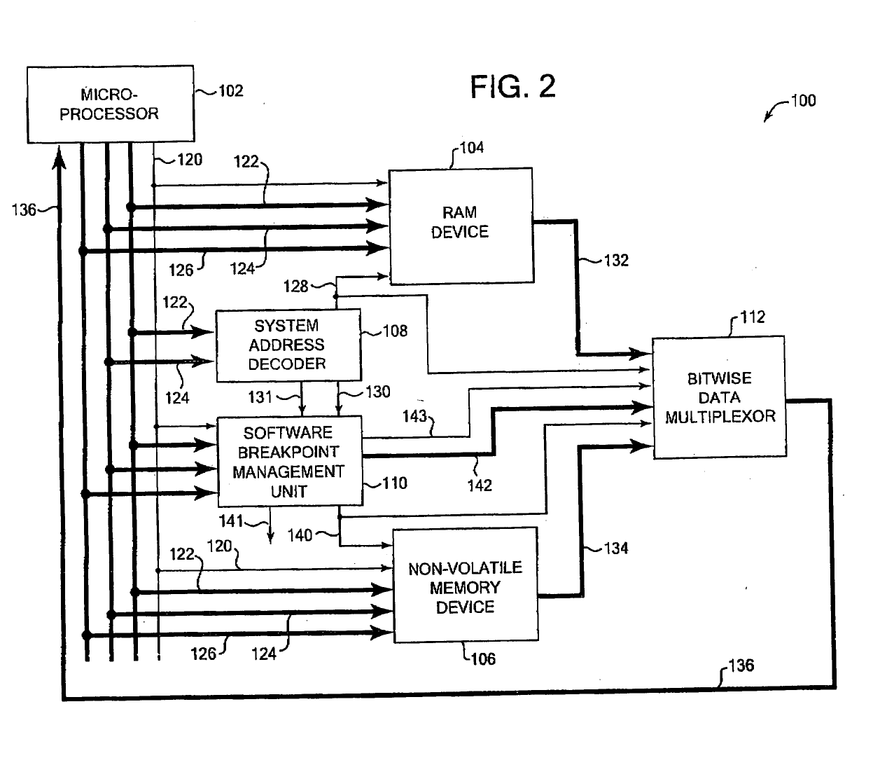

FIG. 2 is a block diagram of one embodiment of a system 100 of the present invention for providing software breakpoints for a system including volatile and non-volatile memory devices. System 100 includes microprocessor 102, RAM device 104, non-volatile memory (NVM) device 106, system address decoder 108, software breakpoint management unit (SBMU) 110, and bitwise data multiplexer 112.

Microprocessor 102 generates control signals when performing read or write accesses to slave devices (such as the memory devices 104 and 106). In the described embodiment, the microprocessor 102 is included on the same chip or integrated circuit as the other components of system 100. In other embodiments, the microprocessor 102 can be provided separately from the other components. Microprocessor 102 can be any type of suitable microcontroller.

The RAM device 104 is able to store data which can be later overwritten or erased, and thus can easily store standard software breakpoints from a debugging agent typically run externally and operating through microprocessor 102. RAM device 104 can be any of a variety of programmable memory devices, typically volatile memory such as static random access memory (SRAM).

The NVM device 106 is a non-volatile memory device that stores data that can be read by microprocessor 102. However, data cannot be easily written or changed by a simple microprocessor write access. The term “non-volatile memory device,” as used herein, refers to standard read-only memory (which is programmable only once), erasable programmable read only memory (EPROM), electrically erasable programmable read-only memory (EEPROM), and flash memory, as well as any other similar types of non-volatile memory. All of these referred types of memory cannot be easily used with software breakpoints, since they do not have the versatility in programming that volatile memory such as RAM 104 has, and cannot have data written to them with a simple microprocessor write access.

The control signals produced by microprocessor 102 include a read/write control signal 120, an access size control bus 122, an address bus 124, and a write data bus 126. The read/write control signal 120 selects the read or write operation to enable that operation for a memory device 104 or 106. The address bus 124 is coupled to the system address decoder 108 to provide addresses in memory device 104 or 106 to the decoder 108. The access size control bus 122 can also be coupled to the decoder 108 if address misalignment is to be managed. The system address decoder 108 generates slave select signals for the slave devices to indicate to the appropriate slave device to perform a transfer requested by the master (the microprocessor 102), such as a read or a write operation. The slave select signal 128 is provided to RAM device 104, and the slave select signal 130 intended for NVM device 106 is provided to the software breakpoint management unit (SBMU) 110.

The write data bus 126 couples the microprocessor 102 to the memory devices 104 and 106 and SBMU 110 and provides the data from the microprocessor that is to be written to a memory device 104 or 106 at the location specified by the address value on the address bus 124 (a write data bus can be used for NVM device 106 if it is an EEPROM or flash memory, for example). A software breakpoint pattern can be sent on the write data bus 126 by a debugging agent which is typically used when debugging an application program. The debugging agent can also send the original instruction, that was replaced by the breakpoint pattern, on the write bus 126, to replace the breakpoint pattern. During normal operation, when the microprocessor 102 is running a program that is retrieving and executing instructions stored in memory 104 or 106 and retrieves the breakpoint pattern, an exception occurs such that the execution of the program is halted and an exception handler momentarily takes control of the processor, provides information to the debugging program, etc.

The SBMU 110 manages software breakpoints that are set for NVM device 106. The SBMU 110 filters the incoming slave select signal 130 for NVM device 106 by replacing it with a new slave selection signal 140 for the NVM device 106. The selection signal 140 is sent to the NVM device 106 to perform a normal read operation when the microprocessor's read access does not correspond to a breakpoint, i.e., when the read access is at an address that is not a breakpoint address. When the read access is at a breakpoint address, the SBMU 110 does not provide selection signal 140, and instead substitutes the breakpoint pattern via the SBMU output data bus 142. Thus, the SBMU 110 bypasses the response from NVM device 106 given through the NVM output bus 134 by filtering the NVM selection signal 140 when the instruction fetch corresponds to a breakpoint.

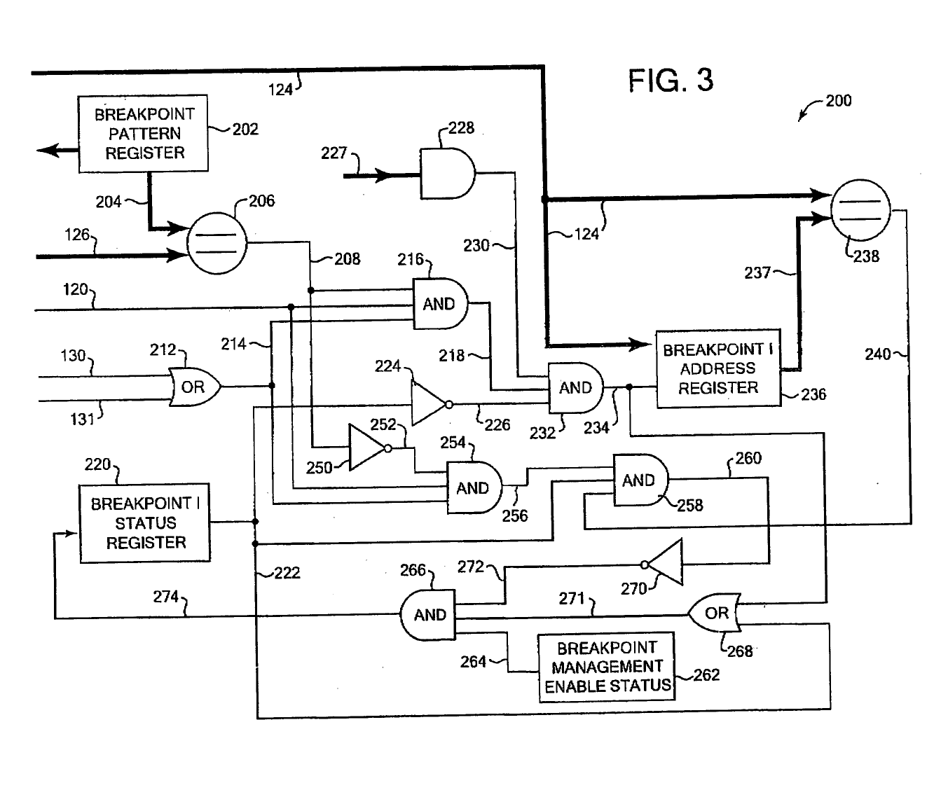

For a write access to NVM device 106, the SBMU 110 detects and checks the write operations. If the SBMU 110 detects the write of a breakpoint pattern, the related address is stored into an address cache as a breakpoint address, thus effectively storing the software breakpoint for the NVM device 106. If the SBMU 110 detects the write of the original instruction to be restored (data that is not the breakpoint pattern), then the related breakpoint address cache is released (cleared). This operation is described in greater detail below with respect to FIGS. 3-6.

The output bus 132 of RAM device 104, the output bus 134 of NVM device 106, and the output bus 142 of SBMU 110 are coupled to the bitwise data multiplexer 112, which multiplexes the output buses 132, 134, and 140 and provides data on these buses to the microprocessor 102 via a read data bus 136. The multiplexer 112 also receives the memory selection signals 128 and 140, as well as an SBMU selection signal 143, which informs the multiplexer whether to send the data on the SBMU data bus 142 over the read data bus 136 (i.e., when a read access to a breakpoint address is made), or to send the data on the NVM output bus 134.

It should be noted that additional non-volatile memory devices can be coupled to the software breakpoint management unit (SBMU) 110, where the SBMU can provide software breakpoints for any and all of the connected non-volatile memories. The system address decoder 108 can send an additional selection signal to the SBMU 110 for each additional non-volatile memory device used, and SBMU 110 can send a corresponding selection signal to an additional non-volatile memory device when appropriate. For example, decoder selection signal 131 for a second non-volatile memory device can be sent from system address decoder 108 to SBMU 110, and SBMU 110 can send out selection signal 141 to the second non-volatile memory device (not shown). Having a single unit such as SMBU 110 control software breakpoints for multiple non-volatile memory devices is a major advantage of the present invention, since the processing logic or cache memory of the SBMU does not need to be duplicated for each additional non-volatile memory device, thereby greatly reducing the logic and registers needed, as well as the cost of the system.

FIG. 3 is a schematic diagram of a store and clear breakpoint circuit 200 that is included in the software breakpoint management unit (SBMU) 110 of FIG. 2. This circuit 200 is used when a debugging agent wishes to store a software breakpoint in the NVM device 106, or when the debugging agent wishes to restore the original instruction in the NVM device 106 at the memory location storing the software breakpoint.

The SBMU 110 allows N software breakpoints to be stored (set), using N sets of dedicated registers in the SBMU. In the following description, the software breakpoint that is being stored or cleared is labelled I, and one or more other software breakpoints are labelled J, where I and J are indexes into the range between 0 and (N−1) breakpoints.

A software breakpoint pattern is stored in a breakpoint pattern register 202. In the described embodiment, this same breakpoint pattern is used as the pattern for all stored breakpoints for NVM device 106. This pattern, when recognized by the software on the microprocessor during regular execution of code, causes a break in the program execution for debugging purposes.

The breakpoint pattern is sent from register 202 via bus 204 (bus 204 is equivalent to the output bus 142 in FIG. 2) to comparator 206, which compares the breakpoint pattern to data received on the input write data bus 126. The data on the write data bus 126 is data that the debugger running on microprocessor 102 wishes to write to the NVM device 106. If the data on the write bus 126 is a breakpoint pattern, then it is a storing operation, in which the debugger wishes to store the breakpoint at a specified address. If the data is other data that is not the breakpoint pattern, then it is assumed to be a clear operation, in which the debugger wishes to restore the original data that was stored at the breakpoint's memory address.

The comparator 206 compares the breakpoint pattern to the data and generates a comparison flag 208 indicating whether the two inputs to the comparator are equal (high) or not (low). If the data on the comparator's two inputs are equal, the data on the write data bus 126 matches the software breakpoint pattern.

The non-volatile memory input selection signals 130 and 131 are provided by the system address decoder 108, where signal 130 is the selection signal for NVM device 106 and signal 131 is the selection signal for a different non-volatile memory device, if present. These signals can select which of multiple non-volatile memories, including NVM device 106, that the microprocessor wishes to read data from. If additional non-volatile memory devices are used, then each additional memory device can have its own signal similar to signals 130 and 131. The selection signals 130 and 131 (and any other selection signals) are logically combined at OR gate 212 to generate a global selection signal 214, indicating that a non-volatile memory device has been selected. The comparison flag 208, the read/write control signal 120 (with a write command or inverted read command, and from microprocessor 102 as shown in FIG. 2), and the global selection signal 214 are input to AND gate 216, which produces a store breakpoint command 218. The store breakpoint command, if true, indicates that the debugger's write access to NVM device 106 is a store breakpoint operation, and that the characteristics of the current write access on bus 126 must be stored.

A breakpoint status register 220 stores a status bit or “tag” for the breakpoint I; if the bit is 0, then the registers for breakpoint I are not in use, and if the bit is 1, the registers are in use. The bit from status register 1220 is sent out on line 222 to an inverter 224, which generates a flag signal 226. The flag signal 226, when high, indicates that the set of registers for breakpoint I is not in use.

There are also (N−1) other software breakpoints that can be stored in dedicated registers in the SBMU 110. Each of these other breakpoints has a breakpoint status register similar to register 220 and an address register similar to address register 236, as well as its own logic circuit similar to circuit 200, and which are not shown in FIG. 3. Any other software breakpoint that was set prior to the current breakpoint I is referred to herein as breakpoint J, where J<I.

Status register bits 227 from the breakpoint status registers J are subject to a bitwise AND operation at AND gate 228, i.e., all the J status bits are ANDed. A status flag signal 230 is generated from the AND gate 228 that indicates when all of the previous set of registers J (where J<I) are already in use, i.e., when the breakpoints J were previously set and are already in use.

Status flag signal 230, store breakpoint command 218, and status flag signal 226 are all input to AND gate 232 which generates a store breakpoint I command 234. Thus, the command 234 is only generated when all previous breakpoints are in use, when the current breakpoint register is free to store a breakpoint, and when the incoming data of a write operation matches the breakpoint pattern. The store breakpoint command 234 is provided from AND gate 232 to the breakpoint I address register 236, and is used to enable the storage of the value of the input address bus 124 in the address register 236.

Other portions of the circuit 200 are used when a software breakpoint is to be stored or cleared. The input address bus 124 is compared to the addresses stored in the breakpoint address registers. This is accomplished when the address 237 stored in the breakpoint I address register 236 is input to the comparator 238 to be permanently compared to the data on the address bus 124. A comparison flag 240 is generated by the comparator 238, and this flag indicates whether or not the data on the address bus 124 matches the breakpoint address where the software breakpoint I has been set.

If the comparison flag 240 is true, a match has occurred, and the action to be taken depends on whether it is currently a write access to clear the breakpoint by the debugger, or a read access during program execution to read the instruction at the breakpoint address. This write or read access is indicated by the control signal 120. If the current access is a write access, then the related breakpoint I in use can be cleared (if the incoming pattern is not equal to the software breakpoint pattern) or stored (if the incoming pattern is equal to the software breakpoint pattern). If the current access is a read access, then the SBMU 110 can return the software breakpoint pattern stored in the breakpoint pattern register 202 on the output data bus 142 to the bitwise data multiplexer 112, as shown in FIG. 2, so that it is returned to the microprocessor 102.

To clear the software breakpoint I, the matching software breakpoint pattern comparison flag 208 is sent to an inverter 250 to be inverted, generating a flag 252 that, if it is high, indicates that the data on the incoming write data bus 126 is not equal to the software breakpoint pattern, and thus is a clear operation. Flag 252, write input command signal 120, and global selection signal 214 are input to AND gate 254, which produces a clear breakpoint command 256. The clear breakpoint command 256, the breakpoint I status register bit 222 (indicating, if high, that the breakpoint I is in use), and the address comparison flag 240 (indicating that the addresses of the data to be written and the address register 236 match) are all input to AND gate 258, which produces a clear breakpoint I signal 260. Thus, the clear software breakpoint I command 260 is active only when the breakpoint I registers are in use, when the input address bus matches the breakpoint I address, and when the current write access is not to store a breakpoint pattern.

When storing or clearing a breakpoint I, the breakpoint I status register 220 must be set or cleared, respectively. A breakpoint management enable status register 262 stores an enabled status or a disabled status for breakpoint management. In the described embodiment, only when this register 262 is enabled can a breakpoint be stored. Typically, the management register 262 is enabled during debugging. The register's status is sent as signal 264 to an AND gate 266. The store breakpoint I command 234 and the breakpoint I status register bit 222 are input to an OR gate 268, whose output 271 is a set breakpoint status register bit command provided to the AND gate 266. The third input to the AND gate 266 is the clear breakpoint I command 260 which has been inverted by inverter 270 on line 272. The AND gate 266 produces a set/clear breakpoint I status register bit command 274, which is provided to the breakpoint I status register 220 to set its state. Thus, a breakpoint I “in use” status is set in breakpoint I status register 220 only when a store breakpoint I command 234 is active and while the clear breakpoint I command 260 is not active. Conversely, the breakpoint I status register 220 is cleared only when a clear breakpoint I command 260 is active (which is also when the breakpoint management of the system is disabled through register 262). When the breakpoint I status register is cleared, then the set of registers for breakpoint I is considered cleared, and a new address for a new breakpoint can then be written into address register 236 (over the old address).

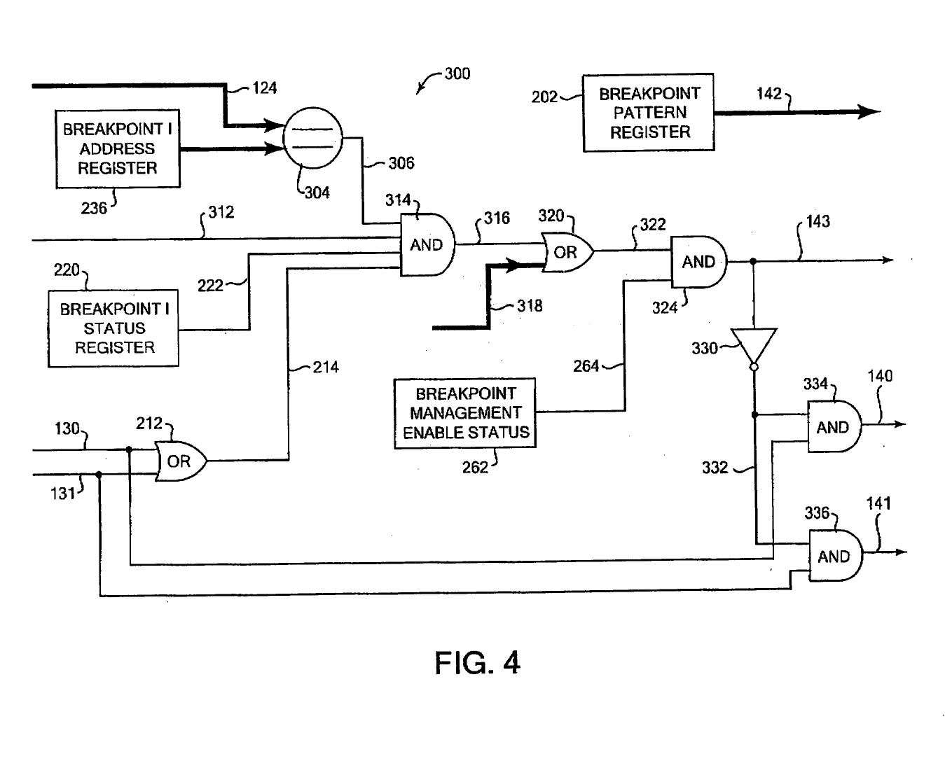

FIG. 4 is a schematic diagram of a breakpoint providing circuit 300 included in the software breakpoint management unit (SBMU) 110 of FIG. 2 for providing a breakpoint pattern instead of a stored instruction during a read access. The breakpoint pattern is provided when the microprocessor 102 requests data at the breakpoint address with a read operation to NVM device 106.

When microprocessor 102 (or other master device) is performing a read access to a memory location where a software breakpoint has been previously set, the circuit 300 is in charge of providing the breakpoint pattern to be put on the read data bus 136 in place of the data in the non-volatile memory 106 that the microprocessor 102 is intending to access. The breakpoint pattern is stored in the breakpoint pattern register 202 (as also shown in FIG. 3) which sends out the breakpoint pattern on bus 142 to the multiplexer 112 as shown in FIG. 2.

Circuit 300 includes additional logic used to filter selection signals for multiple non-volatile memory devices such as NVM device 106 while generating a selection signal related to the SBMU 110 that is provided to the multiplexer 112. This additional logic used to filter selection signals is used if a multiplexed architecture is used for the read data bus, or in any other architectures, since data selection or enable (for tri-state busses) needs this filtering.

The address stored in the breakpoint I address register 236 and the incoming address bus 124 are input to a comparator 304, which compares the signals and generates a comparison signal 306 indicating if the data on the address bus 124 matches the address related to the breakpoint I location. The non-volatile memory selection signals 130 and 131 are provided to OR gate 212 (the same as in FIG. 2) to produce the single non-volatile memory selection signal 214. The selection signal 214, the match breakpoint I address comparison signal 306, a read control signal 312 resulting from inversion of microprocessor signal 120 (so active high during read operations), and the breakpoint I status register bit 222 from breakpoint I status register 220 are provided as inputs to AND gate 314. AND gate 314 produces the signal 316 which indicates whether the current read access matches the breakpoint I address.

Each of the N software breakpoints provided by the system 100 requires a comparator coupled to an AND gate using the same input signals, similar to comparator 304 and AND gate 314, and which are not shown in FIG. 4. The addresses of the other in-use breakpoints J in the SBMU 110 are compared to the current read access by their respective comparators and AND gates. All the resulting signals (similar to signal 316), each indicating whether the current read access matches a software breakpoint J address (with J different than I), are represented as bus 318 in FIG. 4 and are provided at inputs of an OR gate 320. The breakpoint I signal 316 is also provided at an input of OR gate 320, and the OR gate produces a signal 322 that indicates whether the current read access matches a software breakpoint location, i.e., matches an address of any breakpoint currently in use by the debugger in SBMU 110.

Signal 322 is provided to an input of AND gate 324 along with the status flag 264 from the software breakpoint management enable status register 262, which indicates whether the breakpoint management is enabled (register 262 is set as a result of a configuration made through the microprocessor 102 or from a test configuration; breakpoint management and the SBMU 110 can be enabled or disabled (default is disabled), so that the SBMU functionality is only enabled when necessary). The output of AND gate 324 is a SBMU data selection signal 143. The selection signal 143 is output from the SBMU and is also input to an inverter 330 which generates a flag 332 indicating whether there is (low), or is not (high), a breakpoint set at the address which is being accessed. Flag 332 is used as a gate signal for the selection signals 140 and 141, where the flag 332 is provided at an input to the AND gate 334 and an input to the AND gate 336, and the selection signal 130 is input to AND gate 334 while the selection signal 131 is input to AND gate 336. Thus, the flag 332 acts to let through needed memory selection signal 130 to the NVM device 106 as signal 140 (or lets through signal 131 as signal 141 to a different non-volatile memory device) only when the read access is not performed at a location storing a software breakpoint. This allows the NVM device 106 to provide non-breakpoint data stored at the address requested by the microprocessor.

The SBMU selection signal 143 is received and used by the read data bus multiplexer 112 to cause the multiplexer 112 to select the breakpoint pattern received from the SBMU 110 on bus 142 from the breakpoint pattern register when a read access to a breakpoint address is performed, instead of selecting data from the bus 134 received from the NVM device 106 (the breakpoint pattern register 202 preferably is always sending out the breakpoint pattern). The multiplexer 112 then sends the breakpoint pattern to the microprocessor 102 on bus 136 as shown in FIG. 2.

The present invention thus allows software breakpoints to be set for multiple different memory devices using a minimum of components. The logic of the SBMU 110 is able to manage several software breakpoints at system frequency (full speed) on one or more memory devices without any addition of cache memory or complex logic. For example, the logic described above in FIGS. 3-4 can manage N software breakpoints and need only include one programmable register able to define the breakpoint pattern (programmed via the debugger currently in use to its own specific value for the breakpoint pattern), one comparator 206 to compare the data in a write access with the breakpoint pattern, N registers for address storage, N status register bits 220 to provide in-use status for the breakpoints, and N comparators 238 to compare an input address with the stored addresses in the address registers.

In alternate embodiments, additional components can be included. For example, if breakpoint size must be variable due to variable data sizes, then N registers (where N is the number of breakpoints) can be provided for memorizing the size of a written breakpoint pattern in addition to the breakpoint address. An additional status register can be included to indicate whether the maximum number of software breakpoints that the SBMU 110 is able to manage, have been set. Also, pipeline stages can be included in the implementation of the invention, as required by system bus architecture, as is well-known. If such pipeline stages are used, then the buses and lines shown in FIG. 2 may be passed through pipeline stage(s) before or after their equivalents are shown in FIG. 3 or 4. For example, buses and lines 120, 124, 130, 131, and 126 of FIG. 2 can be passed through a synchronization stage (pipeline stage) before being received at components as shown in FIGS. 3 and 4.

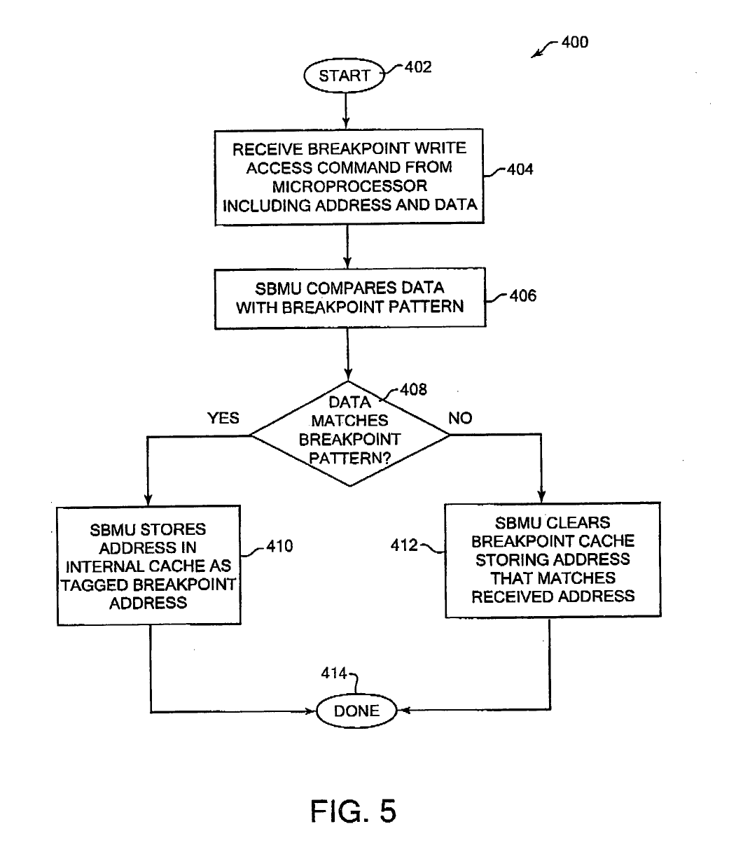

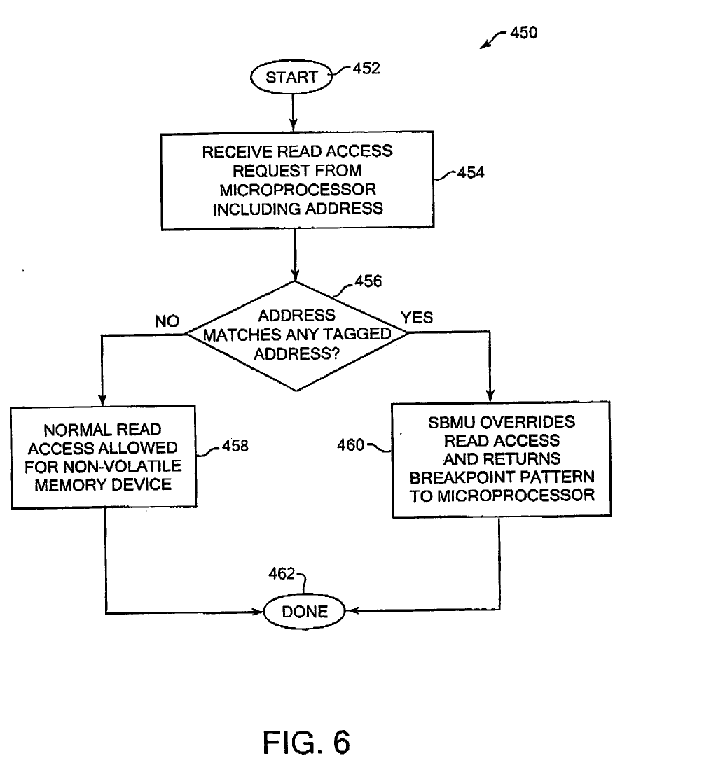

FIG. 5 is a flow diagram illustrating a method 400 of the present invention for managing software breakpoints during a write access to a non-volatile memory, such as NVM device 16. This process describes setting or clearing a software breakpoint; the process including reading a breakpoint pattern previously set is described below with respect to FIG. 6.

The method starts at 402, and in step 404, the SBMU 110 receives a breakpoint write access command from the microprocessor 102, typically originating from a debugger program agent (typically running on a device separate from the microprocessor) that the user is utilizing during debugging procedures. The write access usually includes an address in the memory (provided on address bus 124), and data that is to be written to that address (provided on write data bus 126). Although it is a non-volatile memory device 106 that cannot be simply written to or erased during operation, the debugger does not know this, and assumes it can be written to. For example, the debugger can use a JTAG port to send data directly to a memory device via the microprocessor without requiring any application running on the microprocessor to talk to the memory.

With this write access, the debugging agent may wish to set (i.e., write) a software breakpoint instruction at a particular address of the NVM device 106, referred to herein as the “breakpoint address.” This typically entails replacing an existing original instruction at the breakpoint address with the breakpoint instruction (or “pattern”). (The original instruction can be stored in an intermediate memory location or register while the breakpoint is being used). The breakpoint pattern is desired to be placed at a memory location which will be accessed during execution of the program stored in the NVM device 106 which is being debugged, and the user wishes to halt program execution for debugging purposes, e.g. to check the value of variables or memory locations, examine output, etc., at the desired point in program execution. In typical setting operations for software breakpoints, the microprocessor copies the original instruction at the breakpoint address to an intermediate location before writing the breakpoint pattern at the breakpoint address. The original instruction is one of the instructions of the program that is being executed (and debugged). This intermediate location can be located anywhere in memory or other storage area.

Alternatively, the debugger may wish to remove or clear a previously-written software breakpoint with the write access received in step 404, by replacing the breakpoint pattern with the original instruction.

In step 406, the SBMU 110 catches the address and data of the write access that is intended for NVM device 106, and compares the data portion of the write access with the breakpoint pattern, which the SBMU 110 has stored in its breakpoint pattern register. It is assumed herein that the breakpoint pattern is unique and not similar to any actual data.

In step 408, it is checked whether the input data for the write access is the same as the breakpoint pattern. If so, then the debugger is trying to set a breakpoint at the address specified in the write access (a breakpoint address). If this is the case, in step 410 the SBMU 110 stores the address portion of the write access in an internal cache, such as register 236 in the embodiment of FIG. 3, as a tagged breakpoint address. The address is stored only in a register that is free and does not already hold a different software breakpoint that is in use. This address is tagged, indicating that the breakpoint at this address is in use, and that no other breakpoints can be stored at this address. For example, a status register like register 220 of FIG. 3 can be associated with the address register 202 and can have a bit set as the tag. The process is then complete at 414.

If the input data does not match the breakpoint pattern in step 408, then the process continues to step 412. This is assumed to indicate that the debugger is trying to clear the breakpoint by replacing the breakpoint pattern at the address specified in the write access with the original instruction; the original instruction is the data portion of the write access. In this case, the SBMU 110 clears (releases) the cache storing the breakpoint address that matches the input address in the write access. For example, in the embodiment of FIG. 3, the clearing of the breakpoint is accomplished by clearing status register 220, associated with the matching address cache (the address in the address register need not be cleared, and can be written over with another breakpoint address). To keep the logic and functionality of the SBMU simple, and maintain compatible functionality of the system, the SBMU does not examine the original instruction (the data itself) that is included in the write access, and makes the assumption that if the debugger wishes to store data at the breakpoint address that is not the breakpoint pattern, it is the original instruction. Note that, since the original instruction was never actually replaced by the breakpoint pattern in the NVM device 106, the original instruction sent in the write access does not need to be written in any memory. The process is then complete at 414.

In the described embodiment, the SBMU 110 can store N breakpoints, where N is one less than the number of programmable registers (one register is needed to program the breakpoint pattern in relation to the debugger in use). If all the available registers store a breakpoint that is in use, then additional breakpoints are not stored. However, as soon as a software breakpoint is cleared, a new breakpoint can then be set.

FIG. 6 is a flow diagram illustrating a method 450 of the present invention for managing software breakpoints for a read access of a non-volatile memory during program execution. This process describes the situation where the microprocessor 102 executes a program having code instructions stored in the NVM device 106, a request is made to read the breakpoint address, and a software breakpoint is provided to the microprocessor. This read access occurs during the execution of the program running on the microprocessor 102, and is typically not initiated by the debugging agent. If the microprocessor retrieves what it recognizes as a breakpoint pattern, it will halt execution, allowing the user to debug the program more easily.

The method starts at 452, and in step 454, the SBMU 110 receives a read access (code fetch) request that is intended for data stored in the NVM device 106. The code fetch request includes an address in the NVM device from which the data is desired to be retrieved, provided on address bus 124 of FIG. 2.

In step 456, the SBMU checks whether the address of the fetch request matches any of the cached and tagged addresses. The tagged addresses are those addresses used to store a software breakpoint, and the software breakpoints are actually stored in a cache (such as registers) in the SBMU 110, as described above with reference to FIG. 3, and not in NVM device 106. If the read access request address does not match any tagged addresses, then the requested address does not hold a breakpoint, and the process continues to step 458, in which the SBMU 110 allows a normal read access of the data at the requested address in the NVM device 106. In the embodiment of FIG. 2, the SBMU 110 can provide the select signal 140 to the NVM device 106 to allow the read operation. The requested data at the requested address is sent by the NVM device 106 to the multiplexer 112 and to the microprocessor via the read data bus 136. The process is then complete at 462.

If the fetch request address does match a tagged address at step 456, then the microprocessor 102 has requested an address that stores a breakpoint, and the process continues to step 460. In step 460, the SBMU 110 overrides (or bypasses) the read access to the NVM device 106 and instead substitutes the breakpoint pattern for any data at that address in the NVM device. The breakpoint pattern, stored in a register of the SMBU, is provided to the multiplexer 112, which provides the pattern to the microprocessor 102 via the read data bus 136. The process is then complete at 462.

The microprocessor 102 executes the received breakpoint pattern and performs the appropriate exception routines. After the exception, if the original instruction (that was replaced by the breakpoint pattern) needs to be executed, then the write access request to restore the original instruction (and clear the breakpoint) can be processed by the SBMU as described above with reference to FIG. 4. Similarly, the process of FIG. 4 handles a write access for setting a breakpoint in the NVM device 106.

It should be noted that the present invention may be suitable for other types of memory devices which may be volatile, and which are not easily used with software breakpoints and not able to be written to by a simple microprocessor write access.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

What is claimed is:

1. A system for providing a software breakpoint for a memory, the system comprising:
a microprocessor;
a memory device accessible through a data bus and an address bus coupled to the microprocessor; and
processing logic coupled to the memory device and to the microprocessor, the processing logic operative to set the software breakpoint for the memory device by substituting a value to be read from the memory device with a breakpoint pattern, wherein the breakpoint pattern is sent to the microprocessor on the data bus instead of the value.

2. The system of claim 1 further comprising one or more additional memory devices coupled to the microprocessor, wherein the processing logic substitutes a value to be read with the breakpoint pattern for any of the memory devices.

3. The system of claim 2 wherein the processing logic provides a selection signal for each memory device coupled to the processing logic.

4. The system of claim 2 wherein the system includes a multiplexer coupled to each output of the memory devices, wherein the multiplexer sends data on the data bus from any of the memory devices to the microprocessor.

5. The system of claim 2 further comprising a system address decoder coupled to the microprocessor and providing a selection signal to the processing logic for each memory device, wherein the processing logic sends a selection signal to each of the memory devices.

6. The system of claim 1 wherein the memory device is a non-volatile memory device.

7. The system of claim 6 wherein the non-volatile memory device is one of read-only memory (ROM), electrically programmable read-only memory (EPROM), electrically-erasable read-only memory (EEPROM), and flash memory.

8. The system of claim 1 wherein the processing logic includes a dedicated register that stores the breakpoint pattern.

9. The system of claim 1 wherein the processing logic includes a breakpoint address register that stores the address of the memory device where the breakpoint pattern is believed by the microprocessor to be stored.

10. The system of claim 9 wherein the processing logic includes a breakpoint status register that stores a status indicative of whether the address in the breakpoint address register is in use as a software breakpoint.

11. The system of claim 1 wherein the processing logic includes a set of dedicated registers for each breakpoint that is stored by the processing logic, wherein the processing logic stores a plurality of software breakpoints.

12. A method for providing a software breakpoint for use with a memory device, the method comprising:
receiving an address value from a microprocessor in a read access of the memory device; and
substituting a data value stored in the memory device with a breakpoint pattern and providing the breakpoint pattern to the microprocessor.

13. The method of claim 12 wherein the breakpoint pattern is retrieved from a cache included in processing logic coupled to the microprocessor and to the memory device.

14. The method of claim 12 further comprising one or more additional memory devices coupled to the microprocessor, wherein a value from any of the memory devices is substituted with the breakpoint pattern.

15. The method of claim 12 wherein the read access is requested by the microprocessor during the execution of program instructions stored in the memory device.

16. The method of claim 15 wherein an exception is forced after the breakpoint pattern is received by the microprocessor to cause a halt in the execution of the program instructions.

17. The method of claim 12 further comprising comparing the address value with at least one breakpoint address stored in a register of processing logic coupled to the microprocessor and to the memory device, wherein the substituting of the data value is performed only when the address value matches the at least one breakpoint address.

18. The method of claim 17 wherein the data value from the memory device is provided to the microprocessor if the address value does not match any of the breakpoint addresses, wherein the data value is stored at an address of the memory device that equals the address value.

19. The method of claim 12 wherein the memory device is a non-volatile memory device.

20. The method of claim 19 wherein the non-volatile memory device is one of read-only memory (ROM), erasable programmable read-only memory (EPROM), electrically-erasable read-only memory (EEPROM), and flash memory.

21. The method of claim 13 wherein the processing logic includes a breakpoint address register that stores the address of the breakpoint pattern provided to the microprocessor.

22. The method of claim 21 wherein the processing logic includes a breakpoint status register that stores a status indicative of whether the address in the breakpoint address register is in use as a software breakpoint.

23. A method for providing software breakpoints for a memory device, the method comprising:
receiving an address and data in a write access from a microprocessor to the memory device;
storing the address in a breakpoint cache in a breakpoint management unit if the data matches a breakpoint pattern; and
clearing a stored address in the breakpoint cache of the breakpoint management unit if the stored address matches the received address and the data does not match the breakpoint pattern.

24. The method of claim 23 wherein the storing of the address in the breakpoint cache includes storing the address in an available one of a plurality of breakpoint caches, wherein the available breakpoint cache is not storing a different software breakpoint address.

25. The method of claim 23 wherein the clearing of the stored address includes clearing a breakpoint status register in the breakpoint management unit.

26. The method of claim 23 wherein the clearing of the stored address includes clearing one of a plurality of breakpoint status registers, the cleared breakpoint status register being associated with the received address.

27. The method of claim 23 wherein the memory device is one of a plurality of memory devices coupled to the microprocessor, each memory device being accessible by the microprocessor.

28. The method of claim 23 further comprising:
receiving an address in a read access from the microprocessor to the memory device; and
providing the breakpoint pattern to the microprocessor, instead of data in the memory device, if the received address in the read access matches an address stored in the breakpoint cache of the breakpoint management unit.

29. The method of claim 28 wherein the breakpoint pattern is retrieved from a register included in the breakpoint management unit.

30. The method of claim 23 wherein the memory device is a non-volatile memory device.

31. The method of claim 30 wherein the non-volatile memory device is one of read-only memory (ROM), electrically programmable read-only memory (EPROM), electrically-erasable read-only memory (EEPROM), and flash memory.

32. The method of claim 23 wherein the breakpoint management unit includes a breakpoint address register that stores the address of the breakpoint pattern provided to the microprocessor.

33. The method of claim 23 wherein the address and data received in the write access are provided by a debugger that desires to set or clear a software breakpoint in the memory device.

34. The method of claim 33 wherein when the debugger wishes to clear the software breakpoint, the data provided in the write access is an original instruction that was substituted by the breakpoint pattern.

35. A system for providing a software breakpoint for a memory, the system comprising:
a memory device accessible by a microprocessor via a data bus and an address bus; and
processing logic coupled to the memory device and to the data bus and the address bus, the processing logic operative to set the software breakpoint for the memory device by substituting a value to be read from the memory device with a breakpoint pattern, wherein the breakpoint pattern is sent to the microprocessor on the data bus instead of the value.

36. The system of claim 35 further comprising one or more additional memory devices coupled to the microprocessor, wherein the processing logic substitutes a value to be read with the breakpoint pattern for any of the memory devices.

37. The system of claim 36 further comprising a system address decoder coupled to the microprocessor and providing a selection signal to the processing logic for each memory device, wherein the processing logic sends a selection signal to each of the memory devices.

38. The system of claim 35 wherein the memory device is a non-volatile memory device.

39. The system of claim 35 wherein the processing logic includes a set of dedicated registers for each breakpoint that is stored by the processing logic, wherein the processing logic stores a plurality of software breakpoints.
